(19) United States
(12) Patent Application Publication
(10) Pub. No.: US 2018/0088377 A1
(43) Pub. Date: Mar. 29, 2018

(54) LIQUID CRYSTAL LENS AND DRIVING METHOD THEREOF, AND DISPLAY DEVICE

(71) Applicants: BOE Technology Group Co., Ltd., Beijing (CN); BEIJING BOE OPTOELECTRONICS TECHNOLOGY CO., LTD., Beijing (CN)

(72) Inventors: Pengcheng Lu, Beijing (CN); Xue Dong, Beijing (CN); Xiaochuan Chen, Beijing (CN); Wenqing Zhao, Beijing (CN); Qian Wang, Beijing (CN); Lei Wang, Beijing (CN); Ming Yang, Beijing (CN); Jian Gao, Beijing (CN); Rui Xu, Beijing (CN); Xiaochen Niu, Beijing (CN); Haisheng Wang, Beijing (CN); Changfeng Li, Beijing (CN); Shengji Yang, Beijing (CN)

(21) Appl. No.: 15/521,947

(22) PCT Filed: May 30, 2016
(86) PCT No.: PCT/CN2016/083868

§ 371 Date: Apr. 26, 2017

(30) Foreign Application Priority Data
Mar. 16, 2016 (CN) 201610151303.2

(51) Int. Cl. G02F 1/1343; G02F 1/1335; G02F 1/03

(52) U.S. Cl. CPC G02F 1/1343; G02F 1/0311; G02F 1/133526

(57) ABSTRACT

A liquid crystal (LC) lens includes a first substrate, a second substrate and an LC layer interposed between the first substrate and the second substrate, a first electrode structure being disposed at a side of the first substrate adjacent to the LC layer; a second electrode structure being disposed at a side of the second substrate adjacent to the LC layer, at least one of the first electrode structure and the second electrode structure including a first bar electrode layer and a second bar electrode layer insulated from one another and include a plurality of first bar electrodes and a plurality of second bar electrodes, respectively; the first bar electrodes and the second bar electrodes are alternately arranged spatially, and orthographic projections of both of the first bar electrodes and the second bar electrodes on the first substrate and the second substrate are not overlapped.

### CROSS REFERENCE

The present application is based upon International Application No. PCT/CN2016/083868, filed on May 30, 2016, which is based upon and claims priority to Chinese Patent Application No. 201610151303.2, filed on Mar. 16, 2016, and the entire contents thereof are incorporated herein by reference.

### TECHNICAL FIELD

The present disclosure relates to the field of display technology, and in particular, to a liquid crystal (LC) lens and driving method thereof, and a display device.

### BACKGROUND

Three dimensional display (i.e., 3D display) technology is based mainly on human illusion. Generally, two images along different angles of the same object are acquired and provided to a left eye and a right eye of a viewer. Accordingly, a certain parallax may exist in the images in the left eye and the right eye of the viewer. The viewer's brain may generate a synthesis of the left eye image and the right eye image having the parallax and thereby producing a deep perception. According, it is possible to provide a display effect of three dimensional image.

The existing 3D display technology is classified into two categories, i.e., glasses 3D display and naked eye 3D display. Glasses 3D display technology requires to wear special glasses, so it is inconvenient to be applied in portable devices. In the mobile electronic products, more attention is drawn to naked eye 3D display technology. The naked eye 3D display technology is mainly classified into liquid crystal (LC) lens grating and slit grating.

The inventors have found that there are at least the following problems in the prior art: for a liquid crystal lens grating naked eye 3D display technique, a liquid crystal layer is controlled by applying a voltage to two electrodes on two substrates in the LC cell, thereby forming a corresponding lens. However, a gap may exist between the electrodes that control the alignment of the liquid crystal due to process restrictions, so that the transmittance of the lens is not the same throughout the lens, which seriously affects the effect of controlling light using the lens.

It should be noted that, information disclosed in the above background portion is provided only for better understanding of the background of the present disclosure, and thus it may contain information that does not form the prior art known by those ordinary skilled in the art.

### SUMMARY

One aspect of the present disclosure provides a liquid crystal (LC) lens comprising a first substrate, a second substrate opposite to the first substrate and an LC layer interposed between the first substrate and the second substrate, a first electrode structure being disposed at a side of the first substrate adjacent to the LC layer; a second electrode structure being disposed at a side of the second substrate adjacent to the LC layer, at least one of the first electrode structure and the second electrode structure comprising a first bar electrode layer and a second bar electrode layer insulated from one another, wherein the first bar electrode layer comprises a plurality of first bar electrodes and the second bar electrode layer comprises a plurality of second bar electrodes; the first bar electrodes and the second bar electrodes are alternately arranged spatially, and orthographic projections of both of the first bar electrodes and the second bar electrodes on the first substrate and the second substrate are not overlapped.

According to another aspect of the present disclosure, there is provide a method for driving the above LC lens, the driving method comprising:

determining a position of a human eye;

determining an LC lens status corresponding to the position of the human eye, according to a pre-stored lookup table of human eye position versus LC lens status; and

applying a corresponding voltage to the first bar electrode layer and the second bar electrode layer according to the determined LC lens status.

According to a further aspect of the present disclosure, there is provided a display device comprising the above LC lens.

It is to be understood that both the foregoing general description and the following detailed description are exemplary and explanatory only and are not restrictive of the invention, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

FIG. 1 is a structural schematic diagram of a liquid crystal lens according to a first embodiment of the present disclosure;

FIG. 2 is a structural schematic diagram of a liquid crystal lens according to a second embodiment of the present disclosure;

FIG. 3 is a structural schematic diagram of a liquid crystal lens according to a third embodiment of the present disclosure;

FIG. 4 is s schematic view of an operating status of the liquid crystal leans according to the first embodiment of the present disclosure;

FIG. 5 is a schematic view of a status of the liquid crystal lens corresponding to FIG. 4;

FIG. 6 is s schematic view of another operating status of the liquid crystal leans according to the first embodiment of the present disclosure;

FIG. 7 is a schematic view of a status of the liquid crystal lens corresponding to FIG. 6;

FIG. 8 is s schematic view of yet another operating status of the liquid crystal leans according to the first embodiment of the present disclosure;

FIG. 9 is a schematic view of a status of the liquid crystal lens corresponding to FIG. 8;

FIG. 10 is a flow chart of a method for driving the liquid crystal lens according to the first embodiment of the present disclosure; and

FIG. 11 is a schematic view of a display device according to a fourth embodiment of the present disclosure.

### REFERENCE NUMERALS

1. First Substrate; 2. Second Substrate; 3. Liquid Crystal (LC) Layer; 4. Backlight Source; 5. Spectroscopic Film; 6. Polarizing Sheet; 10. First Electrode Structure; 20. Second Electrode Structure; 11. First Bar Electrode Layer; 12. Second Bar Electrode Layer; 13. First Bar Electrode; 14. Second Bar Electrode.

### DETAILED DESCRIPTION

Hereinafter, the present disclosure will be described in further detail with reference to the drawings and particular implementations thereof, such that those skilled in the art may have a better understanding of technical solutions of the present disclosure.

### The First Embodiment

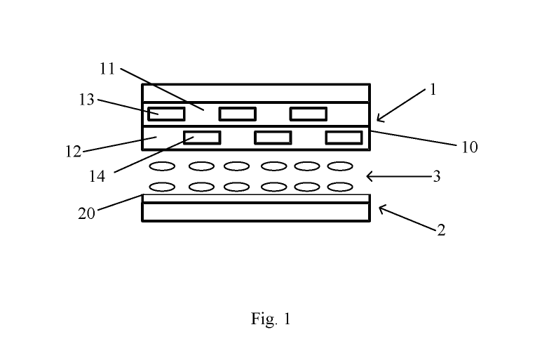

As illustrated in FIG. 1, the present embodiment provides a liquid crystal (LC) lens comprising: a first substrate 1 and a second substrate 2 opposite to the first substrate 1, and an LC layer 3 interposed between the first substrate 1 and the second substrate 2. A first electrode structure 10 is disposed at a side of the first substrate 1 adjacent to the LC layer 3; a second electrode structure 10 is disposed at a side of the second substrate 2 adjacent to the LC layer 3. In the embodiment, the first electrode structure 10 comprises a first bar electrode layer 11 and a second bar electrode layer 12 insulated from one another, wherein the first bar electrode layer 11 comprises a plurality of first bar electrodes 13, and the second bar electrode layer 12 comprises a plurality of second bar electrodes 14. The first bar electrodes 13 and the second bar electrodes 14 are alternately arranged spatially, and orthographic projections of both of the first bar electrodes 13 and the second bar electrodes 14 on for example the second substrate 2 are not overlapped. The second electrode structure 20 is a plate electrode on which a constant voltage is applied.

In the liquid crystal lens of the present invention, since the first electrode structure 10 comprises the laminated first bar electrode layer 11 and second bar electrode layer 12, and the second electrode structure 20 is a plate electrode, a liquid crystal lens is formed between the respective first bar electrode 13 and the plate electrode, and a liquid crystal lens may be formed between the respective second bar electrode 14 and the plate electrode, when an electrical field is formed between the first electrode structure 10 and the second electrode structure 20 having the plate electrode by applying voltages to the respective first bar electrodes 13 in the first bar electrode layer 11 and the respective second bar electrodes 14 in the second bar electrode layer 12. Compared with the liquid crystal lens in the prior art forming a liquid crystal lens between a single layered bar electrode and a plate electrode, the LC lens according to the present disclosure has a smoother gradient and is capable of more accurately controlling light. In addition, the liquid crystal lens of the present disclose may change the driving mode of the electrode (i.e., the case of applying the voltage to the two layers of bar electrodes) according to the monitored human eye position. For example, it is possible to apply voltage to the first bar electrode layer 11 and/or the second bar electrode layer 12 to form the LC lens having corresponding status, thereby ensuring that the viewer may see a correct image and have the best viewing effect.

Preferably, the LC lens of the present embodiment may further comprise a control unit, a human eye tracking unit and an LC lens status determining unit, wherein the human eye tracking unit is configured to position a human eye; the LC lens status determining unit is configured to determine an LC lens status corresponding to a position of the human eye positioned by the human eye tracking unit, according to a pre-stored lookup table of human eye position versus LC lens status; and the control unit is configured to apply a corresponding voltage across the first bar electrode layer 11 and the second bar electrode layer 12 according to the LC lens status determined by the LC lens status determining unit.

The present embodiments is described with reference to a method for driving the LC lens such that the operating principle of the LC lens according to the present embodiment may be more clear.

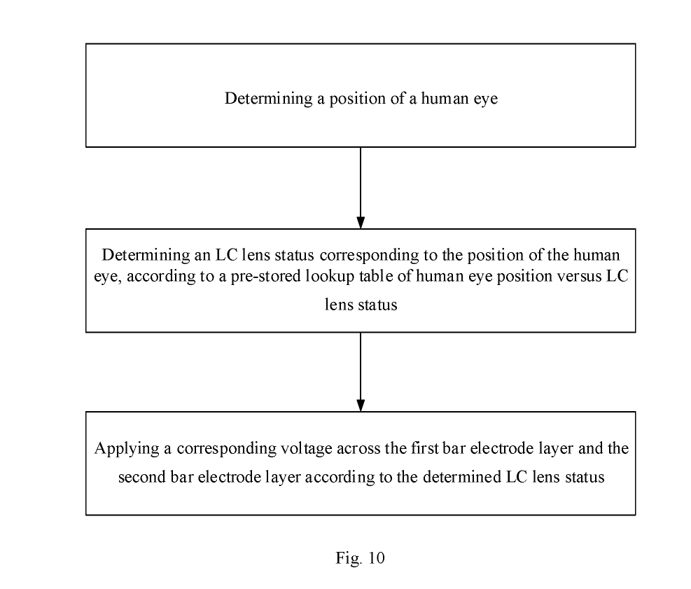

As illustrated in FIG. 10, the method for driving the LC lens of the present embodiment comprises steps 1 to 3.

In step 1, a position of a human eye is determined.

In this step, in particular, it is possible to position the human eye using the human eye tracking unit to determine the position of the human eye.

In step 2, an LC lens status corresponding to the position of the human eye is determined, according to a pre-stored lookup table of human eye position versus LC lens status.

In this step, in particular, it is possible to use the LC lens status determining unit to determine an LC lens status corresponding to the position of the human eye determined in the step 1, according to its pre-stored lookup table of human eye position versus LC lens status.

In step 3, a corresponding voltage is applied to the first bar electrode layer 11 and to the second bar electrode layer 12 according to the determined LC lens status.

In this step, in particular, it is possible to use the control unit to apply a corresponding voltage across the first bar electrode layer 11 and the second bar electrode layer 12 according to the determined LC lens status determined by the LC lens status determining unit in the step two, so as to form the determined LC lens status.

Hereinafter, an example is described.

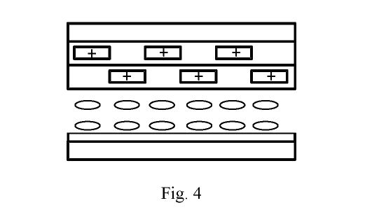

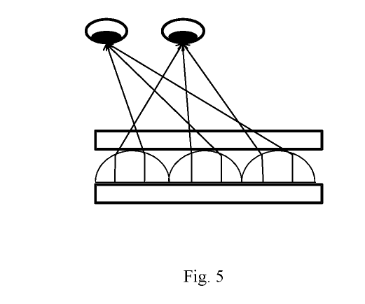

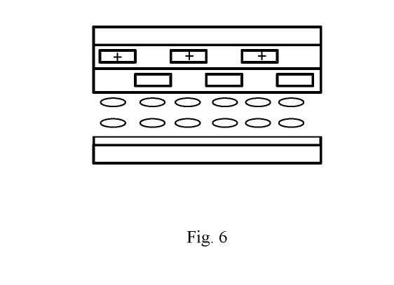

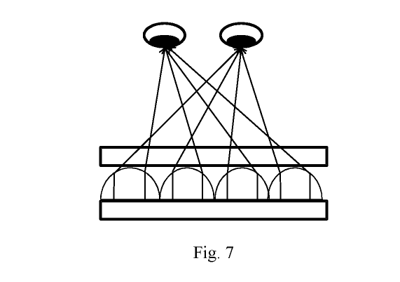

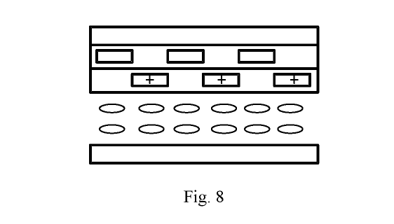

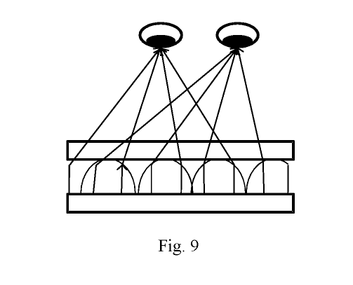

When the human eye tracking unit has positioned a human eye position as a position “a”, a status of the LC lens corresponding to the position “a” is looked up in the pre-stored lookup table of human eye position versus LC lens status, as illustrated in FIG. 5. At this time, it is controlled by the control unit to apply voltage simultaneously to the first bar electrode layer 11 and the second bar electrode layer 12, as illustrated in FIG. 4, so as to form the LC lens status corresponding to the position “a”. Accordingly, the viewer may see a correct image. Similarly, when the human eye tracking unit has positioned a human eye position as a position “b”, a status of the LC lens corresponding to the position “b” is looked up in the pre-stored lookup table of human eye position versus LC lens status, as illustrated in FIG. 7. At this time, it is controlled by the control unit to apply voltage simultaneously to the first bar electrode layer 11, as illustrated in FIG. 6, so as to form the LC lens status corresponding to the position “b”. Accordingly, the viewer may see a correct image. Correspondingly, when the human eye tracking unit has positioned a human eye position as a position “c”, a status of the LC lens corresponding to the position “c” is looked up in the pre-stored lookup table of human eye position versus LC lens status, as illustrated in FIG. 9. At this time, it is controlled by the control unit to apply voltage simultaneously to the second bar electrode layer 12, as illustrated in FIG. 8, so as to form the LC lens status corresponding to the position “c”. Accordingly, the viewer may see a correct image.

It should be noted that, the above lookup table is pre-stored in the LC lens status determining unit. It should be appreciated that a storage module may be provided in the LC lens status determining unit to store the lookup table in the storage module. The lookup table may be a table of correspondence between the human eye position and the LC lens status. For example, the human eye position “a” corresponds to the LC lens status of FIG. 5, the human eye position “b” corresponds to the LC lens status of FIG. 7, and the human eye position “c” corresponds to the LC lens status of FIG. 9.

In the LC lens according to the present embodiment, a distance between adjacent two first bar electrodes 13 equals to a width of a second bar electrode 14. In this way, when voltage is applied simultaneously to the first bar electrode layer 11 and the second bar electrode layer 12, there may be substantially no gap between the first bar electrode 13 and the second bar electrode 14. The LC layer 3 between the first bar electrode 13 and the second bar electrode 14 may also be affected by the electrode field, thereby ensuring that a gradient of the formed LC lens may have a most smooth status.

In the LC lens according to the present embodiment, a width of the first bar electrode equals to a width of the second bar electrode. In this way, while applying voltage simultaneously to the first bar electrode layer 11 and the second bar electrode layer 12, it is possible to ensure a uniformity of the applied voltage.

### The Second Embodiment

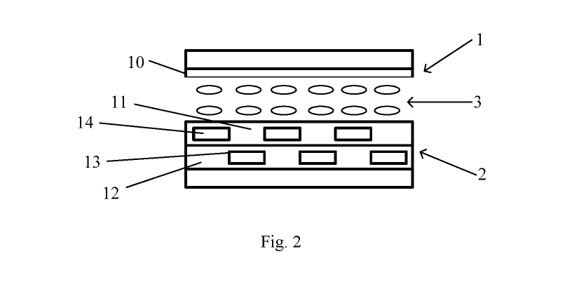

As illustrated in FIG. 2, the present embodiment provides a liquid crystal (LC) lens having a basic structure substantially the same as that of the first embodiment, except that in the LC lens according to the present embodiment, the second electrode structure 20 on the second substrate 2 comprises a first bar electrode layer 11 and a second bar electrode layer 12 insulated from one another, wherein the first bar electrode layer 11 comprises a plurality of first bar electrodes 13, and the second bar electrode layer 12 comprises a plurality of second bar electrodes 14. The first bar electrodes 13 and the second bar electrodes 14 are alternately arranged spatially, and orthographic projections of both of the first bar electrodes 13 and the second bar electrodes 14 on for example the first substrate 1 are not overlapped. The first electrode structure 10 on the first substrate 1 is a plate electrode on which a constant voltage is applied. The operation principle of the LC lens of this structure is the same as that of the LC lens in the first embodiment, while will not be described in detail herein.

### The Third Embodiment

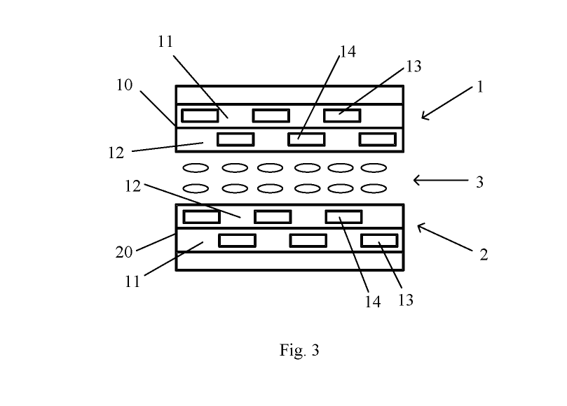

As illustrate in FIG. 3, the present embodiment provides a liquid crystal (LC) lens comprising: a first substrate 1 and a second substrate 2 opposite to the first substrate 1, and an LC layer 3 interposed between the first substrate 1 and the second substrate 2. A first electrode structure 10 is disposed on a side of the first substrate 1 adjacent to the LC layer 3; a second electrode structure 10 is disposed on a side of the second substrate 2 adjacent to the LC layer 3. In the embodiment, both the first electrode structure 10 and the second electrode structure 20 comprise a first bar electrode layer 11 and a second bar electrode layer 12 insulated from one another, wherein the first bar electrode layer 11 comprises a plurality of first bar electrodes 13, and the second bar electrode layer 12 comprises a plurality of second bar electrodes 14. The first bar electrodes 13 and the second bar electrodes 14 are alternately arranged spatially, and orthographic projections of both of the first bar electrodes 13 and the second bar electrodes 14 on for example the first substrate 1 and the second substrate 2 are not overlapped.

During the operation of the LC lens according to the present embodiment, the first bar electrode layer 11 and the second bar electrode layer 12 of one of the first electrode structure 10 and the second electrode structure 20 are applied with a same and constant voltage, and the first bar electrode layer 11 and the second bar electrode layer 12 of the other one is applied with the voltage in a way that is similar to that in the first embodiment and the second embodiment, which will not be repeated herein.

### The Fourth Embodiment

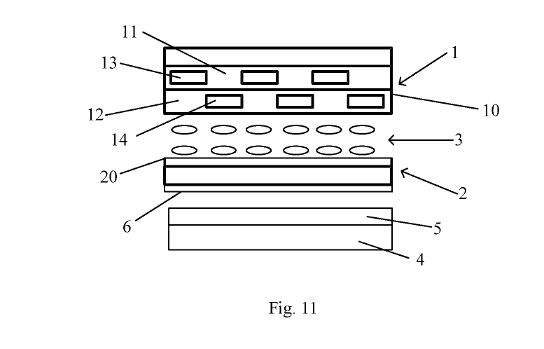

As illustrated in FIG. 11, the present embodiment provides a display device comprising the LC lens according to anyone of the first to third embodiments. The LC lens may be also used as a display panel, and different gray scales may be displayed while forming the LC lens by adjusting the voltage applied to the first electrode structure 10 and the second electrode structure 20.

The display device further comprises a backlight source 4 provided at a light incident side of the LC lens, a polarizing sheet 6 (i.e., a lower polarizing sheet) attached to the light incident side of the LC lens (for example, a side of the second substrate 2 away from the LC layer 3), and a spectroscopic film 5 interposed between the backlight source 4 and the polarizing sheet 6.

In this embodiment, the light emitted from the backlight source 4 is divided into lights of three different colors of red, green and blue, after passing through the spectroscopic film 5, and then passes through the lower polarizing sheet 6 and the LC lens to display image. It can be seen that no color film is required in the display device according to the present embodiment, and an upper polarizing sheet may be omitted, such that the display device may be slim and lightweight.

In the LC lens according to the present embodiment, at least one of the first electrode structure 10 and the second electrode structure 20 comprises a double layer electrode, i.e., the first bar electrode layer 11 and the second bar electrode layer 12. Accordingly, it is also possible to control the voltage applied to the first bar electrode layer 11 and the second bar electrode layer 12, such that a single sub pixel corresponds to a single LC lens, a single sub pixel corresponds to a plurality of LC lenses, or a plurality of sub pixels correspond to a single LC lens.

In the present embodiment, the display device may comprise any product or component having a display function such as a liquid crystal panel, an electronic paper, a mobile phone, a tablet computer, a television set, a display, a notebook computer, a digital album, a navigator, or the like.

It should be appreciated that, the above embodiments are exemplary implementations for illustrating the principle of the present disclosure only, while the present disclosure is not limited thereto. Various modifications and improvements are possible to those of ordinary skill in the art without departing from the spirit and essence of the present disclosure. All these modifications and improvements will also fall into the protection scope of the present disclosure.

1-10. (canceled)

11. A liquid crystal (LC) lens comprising:
a first substrate,
a second substrate opposite to the first substrate,
an LC layer, interposed between the first substrate and the second substrate,
a first electrode structure, disposed at a side of the first substrate adjacent to the LC layer, and
a second electrode structure, disposed at a side of the second substrate adjacent to the LC layer,
wherein at least one of the first electrode structure and the second electrode structure comprises a first bar electrode layer and a second bar electrode layer insulated from one another,
wherein the first bar electrode layer comprises a plurality of first bar electrodes and the second bar electrode layer comprises a plurality of second bar electrodes, and
wherein the first bar electrodes and the second bar electrodes are alternately arranged spatially, and orthographic projections of both of the first bar electrodes and the second bar electrodes on the first substrate and the second substrate are not overlapped.

12. The LC lens according to claim 11, wherein a distance between adjacent two first bar electrodes equals to a width of one of the second bar electrodes.

13. The LC lens according to claim 11, wherein a width of the first bar electrode equals to a width of the second bar electrode.

14. The LC lens according to claim 11, wherein one of the first electrode structure and the second electrode comprises the first bar electrode layer and the second bar electrode layer insulated from one another, and the other one comprises a plate electrode.

15. The LC lens according to claim 11, wherein both of the first electrode structure and the second electrode structure comprise the first bar electrode layer and the second bar electrode layer insulated from one another.

16. The LC lens according to claim 11 further comprising a control unit, a human eye tracking unit and an LC lens status determining unit, wherein:
the human eye tracking unit is configured to position a human eye;
the LC lens status determining unit is configured to determine an LC lens status corresponding to a position of the human eye positioned by the human eye tracking unit, according to a pre-stored lookup table of human eye position versus LC lens status; and
the control unit is configured to apply a corresponding voltage to the first bar electrode layer and apply a corresponding voltage to the second bar electrode layer according to the LC lens status determined by the LC lens status determining unit.

17. A method for driving an LC lens, wherein the LC lens comprises
a first substrate,
a second substrate opposite to the first substrate,
an LC layer, interposed between the first substrate and the second substrate,
a first electrode structure, disposed at a side of the first substrate adjacent to the LC layer, and
a second electrode structure, disposed at a side of the second substrate adjacent to the LC layer,
wherein at least one of the first electrode structure and the second electrode structure comprises a first bar electrode layer and a second bar electrode layer insulated from one another,
wherein the first bar electrode layer comprises a plurality of first bar electrodes and the second bar electrode layer comprises a plurality of second bar electrodes, and
wherein the first bar electrodes and the second bar electrodes are alternately arranged spatially, and orthographic projections of both of the first bar electrodes and the second bar electrodes on the first substrate and the second substrate are not overlapped,
wherein the method comprises:
determining a position of a human eye;
determining an LC lens status corresponding to the position of the human eye, according to a pre-stored lookup table of human eye position versus LC lens status; and
applying a corresponding voltage to the first bar electrode layer and the second bar electrode layer according to the determined LC lens status.

18. The method according to claim 17, wherein a distance between adjacent two first bar electrodes equals to a width of one of the second bar electrodes.

19. The method according to claim 17, wherein a width of the first bar electrode equals to a width of the second bar electrode.

20. The method according to claim 17, wherein one of the first electrode structure and the second electrode comprises the first bar electrode layer and the second bar electrode layer insulated from one another, and the other one comprises a plate electrode.

21. The method according to claim 17, wherein both of the first electrode structure and the second electrode structure comprise the first bar electrode layer and the second bar electrode layer insulated from one another.

22. The method according to claim 17, wherein the LC lens further comprises a control unit, a human eye tracking unit and an LC lens status determining unit, wherein:
the human eye tracking unit is configured to position a human eye;
the LC lens status determining unit is configured to determine an LC lens status corresponding to a position of the human eye positioned by the human eye tracking unit, according to a pre-stored lookup table of human eye position versus LC lens status; and
the control unit is configured to apply a corresponding voltage to the first bar electrode layer and apply a corresponding voltage to the second bar electrode layer according to the LC lens status determined by the LC lens status determining unit.

23. A display device comprising:
an LC lens, wherein the LC lens comprises:
a first substrate,
a second substrate opposite to the first substrate,
an LC layer, interposed between the first substrate and the second substrate,
a first electrode structure, disposed at a side of the first substrate adjacent to the LC layer, and
a second electrode structure, disposed at a side of the second substrate adjacent to the LC layer,
wherein at least one of the first electrode structure and the second electrode structure comprises a first bar electrode layer and a second bar electrode layer insulated from one another,
wherein the first bar electrode layer comprises a plurality of first bar electrodes and the second bar electrode layer comprises a plurality of second bar electrodes, and
wherein the first bar electrodes and the second bar electrodes are alternately arranged spatially, and orthographic projections of both of the first bar electrodes and the second bar electrodes on the first substrate and the second substrate are not overlapped.

24. The display device according to claim 23, further comprising a backlight source provided at a light incident side of the LC lens.

25. The display device according to claim 24, further comprising a polarizing sheet attached to a light incident side of the LC lens and a spectroscopic film disposed between the backlight source and the polarizing sheet.

26. The display device according to claim 23, wherein a distance between adjacent two first bar electrodes equals to a width of one of the second bar electrodes.

27. The display device according to claim 23, wherein a width of the first bar electrode equals to a width of the second bar electrode.

28. The display device according to claim 23, wherein one of the first electrode structure and the second electrode comprises the first bar electrode layer and the second bar electrode layer insulated from one another, and the other one comprises a plate electrode.

29. The display device according to claim 23, wherein both of the first electrode structure and the second electrode structure comprise the first bar electrode layer and the second bar electrode layer insulated from one another.

30. The display device according to claim 23 further comprising a control unit, a human eye tracking unit and an LC lens status determining unit, wherein:
the human eye tracking unit is configured to position a human eye;
the LC lens status determining unit is configured to determine an LC lens status corresponding to a position of the human eye positioned by the human eye tracking unit, according to a pre-stored lookup table of human eye position versus LC lens status; and
the control unit is configured to apply a corresponding voltage to the first bar electrode layer and apply a corresponding voltage to the second bar electrode layer according to the LC lens status determined by the LC lens status determining unit.
